(19) United States
(12) Patent Application Publication
(10) Pub. No.: US 2014/0211455 A1
(43) Pub. Date: Jul. 31, 2014

(54) IMAGE DISPLAY DEVICE WITH ORGANIC LIGHT-EMITTING DIODE

(71) Applicant: WiseChip Semiconductor Inc., Miaoli County (TW)

(72) Inventors: PO-HSIN LIN, Miaoli County (TW); SHIH-HUNG CHANG, Miaoli County (TW); SHANG-CHIH LIN, Miaoli County (TW); I-HSUAN LIN, Miaoli County (TW)

(73) Assignee: WiseChip Semiconductor Inc., Miaoli County (TW)

(21) Appl. No.: 14/163,480

(22) Filed: Jan. 24, 2014

(30) Foreign Application Priority Data
Jan. 30, 2013 (TW) 102201980

(51) Int. Cl. G09F 13/08

(52) U.S. Cl. CPC G09F 13/08
USPC 362/97.4

(57) ABSTRACT

An image display device with organic light-emitting diodes (OLEDs) includes a first cover and an organic light-emitting diode (OLED) module. The first cover has a first light transparent zone and a first mask zone. The first light transparent zone forms a first image. The first mask zone is complementary with the first light transparent zone. The OLED module is positioned against the first cover and includes a plurality of juxtaposed organic light emitting diode (OLED) pixels emitting light to project to the first cover. The light includes transmission light and reflective light. The transmission light passes through the first light transparent zone to display the first image. The reflective light is blocked by the first mask zone. Thus the first image can be displayed with a continuous and smooth border on the curvature contour to improve resolution and visual appeal.

### FIELD OF THE INVENTION

The present invention relates to an image display device and particularly to an image display device with organic light-emitting diodes (OLEDs).

### BACKGROUND OF THE INVENTION

OLEDs have many advantages such as greater durability, lighter in weight and lower power consumption, hence are increasingly used as an illumination source in many areas to gradually replace the traditional STN LCD (Super Twisted Nematic Liquid Crystal Display) and VFD (Vacuum Fluorescent Display).

For instance, U.S. publication No. 2010/0149805 discloses an LED lighting laminate with integrated cooling that mainly includes a plurality of LEDs mounted on a tri-layer laminate which contains an electric insulation middle layer sandwiched between two metal aluminum layers. The upper aluminum layer functions as a radiator and can disperse heat originated from the LEDs faster than the conventional printed circuit board. It also has a fin and a thermal interface material installed on the backside of the tri-layer laminate to enhance cooling effect.

However, in the event that the aforesaid LED lighting laminate is used to display a static image or text message, multiple LEDs have to be deployed and arranged according to the contour of the image or text to meet message display purpose.

The cluster arrangement to define illumination message mentioned above tend to generate serrated edges on the curvature contour of the image or text characters due to the constraint of the shape of the LEDs, hence resolution and visual appeal of the image or text characters suffer, and production cost also is higher. Moreover, when the display model of the conventional PMOLED (Passive Matrix Organic Light-Emitting Diode) Icon display needs to be modified, the mask has to be reproduced for fabricating the panel that violates the fast development trend in the electronic industry. There are still rooms for improvement.

### SUMMARY OF THE INVENTION

The primary object of the present invention is to solve the problems of the conventional LEDs arranged for displaying images and texts via a curvature contour that tend to generate serrated edges and produce undesirable visual angle and color saturation.

To achieve the foregoing object, the invention provides an image display device with OLEDs that includes a first cover and an OLED module. The first cover has a first light transparent zone and a first mask zone. The first light transparent zone forms a first image. The first mask zone is complementary with the first light transparent zone. The OLED module is positioned against the first cover and includes a plurality of juxtaposed OLED pixels emitting light to project to the first cover. The light includes transmission light and reflective light. The transmission light passes through the first light transparent zone to display the first image. The reflective light is blocked by the first mask zone.

By means of the technique set forth above, the invention provides many advantages, notably:

1. The first cover masks the OLED module. Through the transmission light passing through the first light transparent zone and the reflective light blocked by the first mask zone, the first image can be displayed with a continuous and smooth border on the curvature contour, therefore can enhance resolution and visual appeal.

2. The light emitted from the OLED module can improve visual angle and color saturation of the first image during display, and production cost also can be reduced.

3. The mass production speed can be increased and the cost of mold reproduction also can be reduced to meet requirements on the market.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1A is an exploded view of a first embodiment of the invention.

FIG. 1B is a top view of the first embodiment of the invention.

FIG. 1C is a fragmentary enlarged cross section of the first embodiment of the invention.

FIG. 2 is a top view of a second embodiment of the invention.

FIG. 3 is a top view of a third embodiment of the invention.

### DETAILED DESCRIPTION OF THE PREFERRED EMBODIMENTS

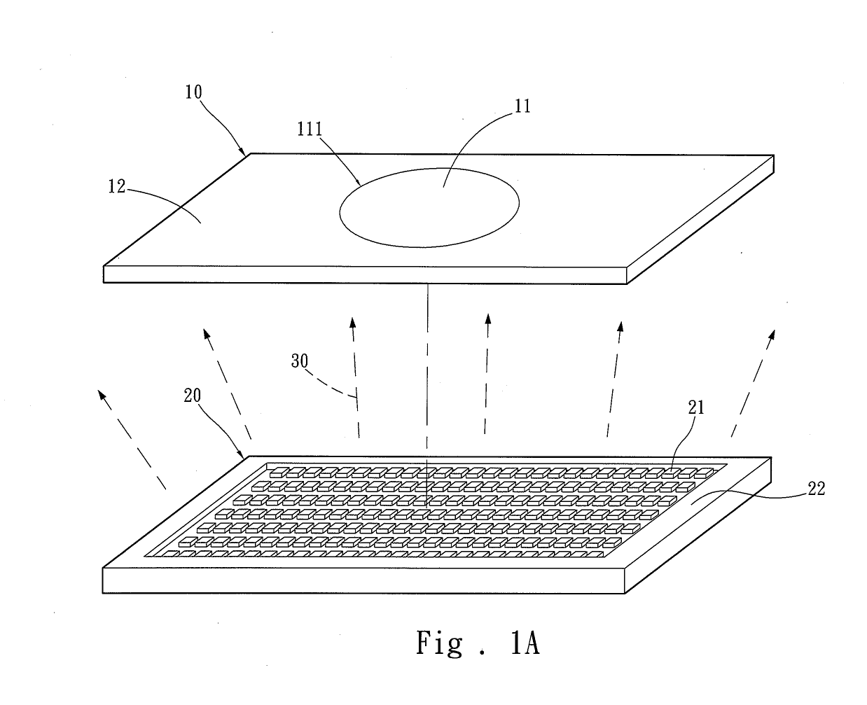

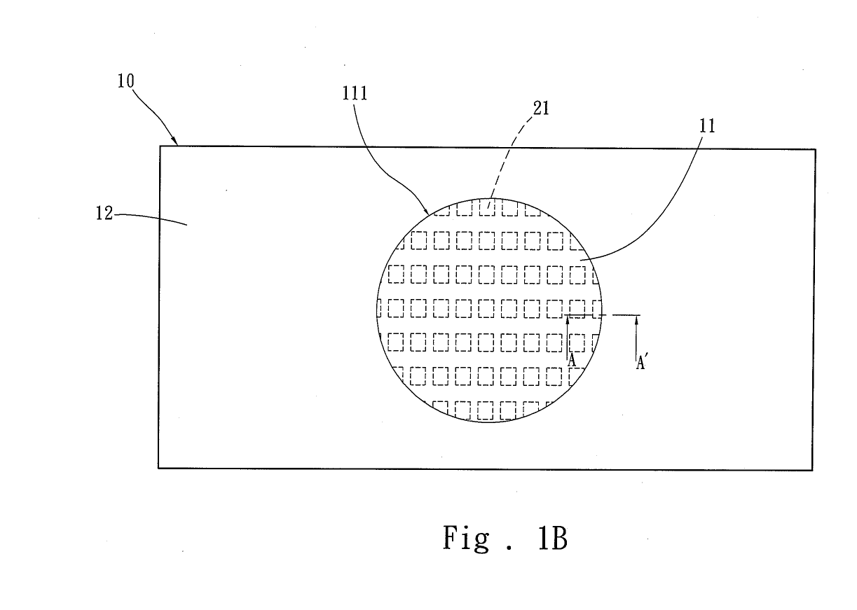

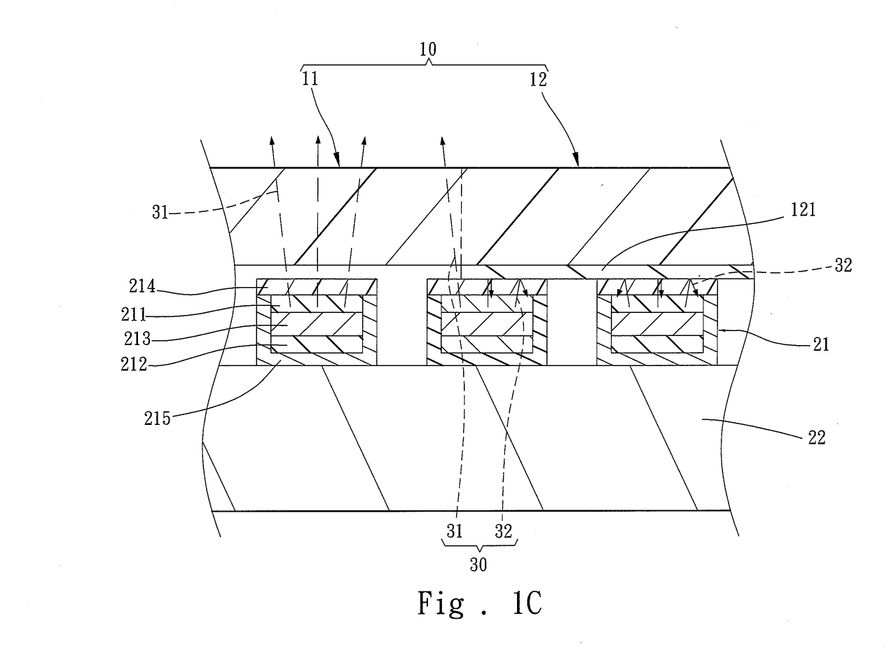

Please refer to FIGS. 1A through 1C for a first embodiment of the present invention. The invention aims to provide an image display device with OLEDs that comprises a first cover 10 and an OLED module 20. The first cover 10 has a first light transparent zone 11 and a first mask zone 12. The first light transparent zone 11 forms a first image 111. The first mask zone 12 is complementary with the first light transparent zone 11. In this embodiment, the first cover 10 can be made of soft or hard material such as glass, plastics or acrylic, such as but not limited to a Mylar film, as long as it is light transparent. The first light transparent zone 11 can be made of light transparent material or formed by a hollow-out area. In the event that the first light transparent zone 11 is made of the light transparent material, it can be formed in one color such as, but not limited to, white, yellow, red, blue or green according to actual requirement. The first image 111 can be a pattern or character formed with a curvature contour. The first mask zone 12 has a mask coating layer 121 proximate or bonded to the first cover 10 and sandwiched between the first cover 10 and OLED module 20.

The OLED module 20 is positioned against the first cover 10 that means the OLED module 20 and first cover 10 are connected in a stacked manner, or can be spaced from each other at a selected distance. The OLED module 20 includes a plurality of OLED pixels 21 and a base 22. The OLED pixels 21 are arranged on the base 22 in a juxtaposed manner, and include respectively a substrate 214, a package lid 215 opposing the substrate 214, an organic light emitting layer 213 located between the substrate 214 and package lid 215, a first electrode 211 located between the organic light emitting layer 213 and substrate 214, and a second electrode 212 located between the organic light emitting layer 213 and package lid 215. In this embodiment the substrate 214 is made of glass. The first electrode 211 is made of a transparent conductive material, such as indium tin oxide (ITO), indium zinc oxide or aluminum zinc oxide. The organic light emitting layer 213 can be made of 1,2,4-triazoles (TAZ), bis-(8-hydroxy)quinaldine aluminum phenoxide (Alq₂OPH), tris-(8-hydroxyquinoline)aluminum (Alq₃) or Triphenyldiamne (TPD). The OLED pixels 21 generate light 30 to pass through the first electrode 211 and substrate 214 to project to the first cover 10.

More specifically, when the light 30 projects to the first cover 10, it projects to the first light transparent zone 11 and first mask zone 12. The light 30 projecting to the first light transparent zone 11 is defined as transmission light 31. The light 30 projecting to the first mask zone 12 is defined as reflective light 32. As the first light transparent zone 11 is made of light transparent material or formed by a hollow-out area, the transmission light 31 can pass through the first light transparent zone 11 to display the first image 111. The first mask zone 12 is coated with the mask coating layer 121, hence the reflective light 32 is blocked by the mask coating layer 121 without passing through the first mask zone 12. As a result, the first mask zone 12 can block the reflective light 32 to define the contour of the first image 111 with a continuous and smooth border. Moreover, when the first light transparent zone 11 is made of the light transparent material with a selected color, the transparent light 31 passing through the first light transparent zone 11 is presented by the selected color. In addition, in this embodiment, the image display device can further include a scattering sheet (not shown in the drawings) between the first cover 10 and OLED module 20. When the light 30 projects to the first cover 10, it passes through the scattering sheet first to be diffused to create a softening effect, and then projects to the first cover 10. Hence the light projecting to the first cover 10 is more uniform to avert forming dark grids while displaying the first image 111 that might otherwise be generated because of unevenness of the arrangement of the OLED pixels 21.

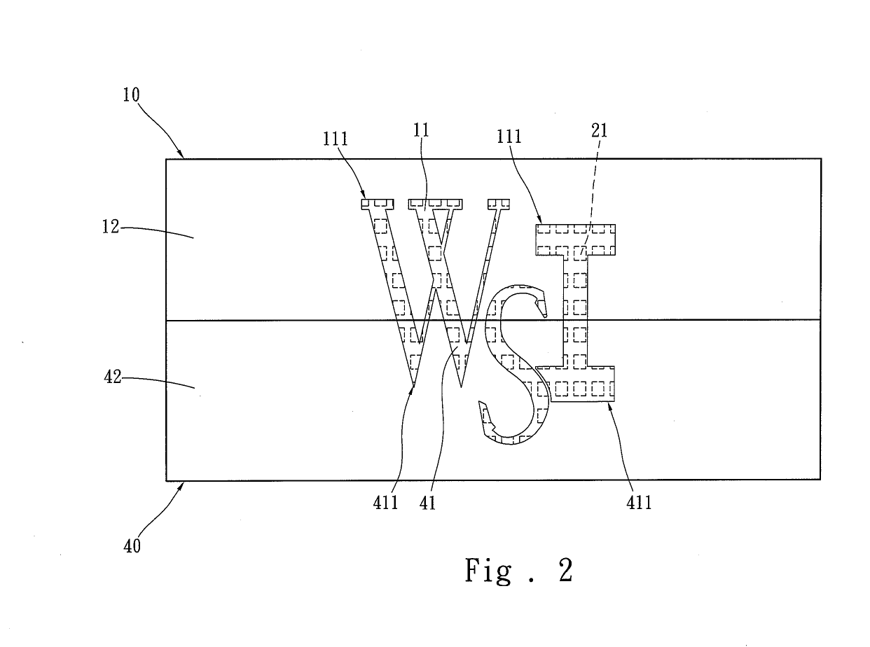

Please refer to FIG. 2 for a second embodiment of the invention. Compared with the first embodiment, the image display device of the invention further has a second cover 40 connected to and juxtaposed with the first cover 10 to receive the light 30 from the OLED module 20. The second cover 40 includes a second light transparent zone 41 to allow the transmission light 31 to pass through and a second mask zone 42 to block the reflective light 32. The second light transparent zone 41 forms a second image 411. The second mask zone 42 is complementary with the second light transparent zone 41. The second light transparent zone 41 is connected to the first light transparent zone 11, and the second mask zone 42 also is connected to the first mask zone 12. Thus, by connecting the second cover 40 with the first cover 10 in a juxtaposed manner, the second image 411 can be connected to the first image 111 to form a greater image display.

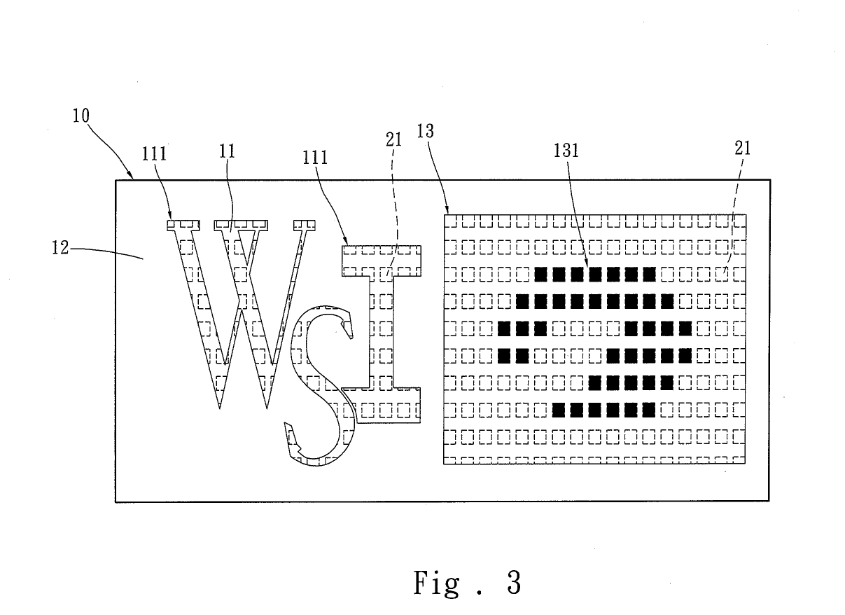

Please refer to FIG. 3 for a third embodiment of the invention. Compared with the first embodiment, the first cover 10 further has a programmable editing display zone 13 complementary with the first mask zone 12 to allow the light 30 to pass through. The OLED module 20 is driven by a programmable editing unit (not shown in the drawings) to allow the light 30 emitted from the OLED pixels 21 to perform programmable editing so that a programmable editing image 131 can be displayed in the programmable editing display zone 13.

As a conclusion, the invention, by masking the OLED module with the first cover, the transmission light can pass through the first light transparent zone and the reflective light can be blocked by the first mask zone to display the first image, thereby the first image has a continuous and smooth border on the displayed curvature contour, and can enhance display resolution and visual appeal. Moreover, compared with the conventional LED light source, the OLED module of the invention can emit light to display the first image at a greater visual angle and higher color saturation. The production cost also can be reduced. In addition, the invention also can provide the programmable editing display zone on the first cover to display the programmable editing image, thereby further expand the application scope. Finally, by connecting the second cover with the first cover in a juxtaposed manner, the displayed image can be formed at a greater size.

What is claimed is:

1. An image display device with organic light-emitting diodes, comprising:
a first cover including a first light transparent zone to form a first image and a first mask zone complementary with the first light transparent zone; and
an organic light emitting diode module including a plurality of juxtaposed organic light emitting diode pixels opposing the first cover and emitting light to project to the first cover, the light including transmission light passing through the first light transparent zone to display the first image and reflective light blocked by the first mask zone.

2. The image display device of claim 1, wherein the first cover includes a mask coating layer on the first mask zone.

3. The image display device of claim 1 further including a second cover connected to and juxtaposed with the first cover to receive the light from the organic light emitting diode module.

4. The image display device of claim 3, wherein the second cover includes a second light transparent zone to form a second image and a second mask zone complementary with the second light transparent zone.

5. The image display device of claim 4, wherein the transmission light passes through the second light transparent zone to display the second image, and the reflective light is blocked by the second mask zone.

6. The image display device of claim 4, wherein the first light transparent zone and the second light transparent zone are connected to each other, and the first mask zone and the second mask zone are connected to each other.

7. The image display device of claim 1, wherein each of the plurality of organic light emitting diode pixels includes a first electrode, a second electrode opposing the first electrode, and an organic light emitting layer located between the first electrode and the second electrode.

8. The image display device of claim 7, wherein the organic light emitting layer generates the light to pass through the first electrode to project to the first cover.

9. The image display device of claim 1, wherein the first light transparent zone is made of light transparent material formed in one color.

10. The image display device of claim 1 further including a scattering sheet located between the first cover and the organic light emitting diode module to soften the light passing through.

11. The image display device of claim 1, wherein the first cover further includes a programmable editing display zone complementary with the first mask zone to allow the light to pass through and display a programmable editing image.
